(19) United States
(12) Patent Application Publication
(10) Pub. No.: US 2011/0211168 A1
(43) Pub. Date: Sep. 1, 2011

(54) PROJECTION SYSTEM

(76) Inventors: Yang-Sik Kim, Seoul (KR); Chan-Young Yoon, Seoul (KR); Yu-Young Joung, Seoul (KR)

(21) Appl. No.: 13/128,937

(22) PCT Filed: Dec. 22, 2008
(86) PCT No.: PCT/KR08/07591

§ 371 Date: May 12, 2011

(30) Foreign Application Priority Data
Nov. 13, 2008 (KR) 10-2008-0112522

(51) Int. Cl. G03B 21/28

(52) U.S. Cl. 353/31; 353/99; 353/84

(57) ABSTRACT

In order to obtain effects of the increase in brightness of images, miniaturization, low cost, convenience of handling, default prevention, in inconvenience of assembly, which are can be obtained by a projection system, the projection system comprises at least one light-emitting device; a time division supplying device of light that time-divides light emitted from the at least one light-emitting device and supplies it; a first condensing lens that focuses light passing through the time division supplying device of light; a first mirror that reflects light passing through the first condensing lens; an integrator that makes light reflected from the first mirror into a planar light; a second mirror that reflects light passing through the integrator; a third mirror that reflects light reflected from the second mirror to a DMD side; and a projection lens that projects light reflected from the second mirror onto a screen and has an optic axis disposed at both sides of the second mirror and the third mirror, respectively.

### TECHNICAL FIELD

The present invention relates to a projection system.

### BACKGROUND ART

A projection system is a device that carries image signals on light light-emitted from a light-emitting device, projects them on a front or rear surface of a screen, and allows a viewer to view them. As the projection system, there are a CRT scheme, a digital micro mirror device scheme, an Lcos scheme, a transmission LCD scheme and the like according to an operation scheme.

As a conventional example of the projection system, there is WO 99/64912A1 (hereinafter, referred to as Cited Document). The Cited Document discloses a scheme that synthesizes light emitted from a light-emitting diode of red, green, and blue colors by a prism and transmits it to a display device such as an LCD display. Further, the prism is disposed around the display device such as an LCD or a DMD forming the image signals and is used for synthesizing the image signals.

However, the scheme using the prism reduces brightness due to a loss of light occurring while light passes through a boundary of each glass structure forming the prism, increases a size of the projection system due to the use of the prism having a large volume, increases the cost of materials and is difficult to assemble, is inconvenient to accurately control an optic axis, and when the optic axis is deviated during the use, needs to correct it, and the like.

### DISCLOSURE OF INVENTION

### Technical Problem

In order to improve all the disadvantages, it is an object of the present invention to provide a projection system that has a small size, convenience of handle according to the small-sized projection system, and assurance of a competitive price, and increases brightness of an image.

### Technical Solution

In order to achieve the objects, a projection system of the present invention comprises: at least one light-emitting device; a time division supplying device of light that time-divides light emitted from the at least one light-emitting device and supplies it; a first condensing lens that focuses light passing through the time division supplying device of light; a first mirror that reflects light passing through the first condensing lens; an integrator that makes light reflected from the first mirror into a planar light; a second mirror that reflects light passing through the integrator; a third mirror that reflects light reflected from the second minor to a DMD side; and a projection lens that projects light reflected from the second mirror onto a screen and has an optic axis, at both sides of which the second minor and the third minor are disposed respectively.

In a projection system that forms images on the screen in a time division scheme, an optic axis of an optical path passing through a projection lens and an optic axis of an optical path passing through an integrator that makes light into a planar light corresponding to the images are distorted in the range of 2 to 18°.

A projection system according to another aspect of the present invention comprises: at least one light-emitting device; a time division supplying device of light that time-divides light emitted from the at least one light-emitting device and supplies it; an integrator that makes light time-divided and supplied from the first mirror into a planar light; at least one condensing lens that focuses light; at least three reflection minors; a DMD that receives light reflected from the at least three mirrors; and a projection lens that projects light emitted from the DMD onto a screen, wherein an optic axis that connects a second mirror disposed at an emitting side of the integrator and a third mirror disposed at an incident side of the DMD is not orthogonal or parallel to any of XYZ-axes on a virtual XYZ coordinate system using the optic axis of the projection as a Y-axis

### Advantageous Effects

With the present invention, the various problems of the conventional projection system can be solved. Further, the present invention can increase the brightness of the image obtainable by the projection system, obtain the small-sized and low cost projection system, make it convenient to handle the projection system, and prevent a default of the projection system and obtain the inconvenience of assembly due to the simple structure and can obtain various advantages in addition to the above-mentioned advantages.

### BRIEF DESCRIPTION OF DRAWINGS

FIG. 1 is a plan view of a projection system according to an exemplary embodiment;

FIG. 2 is a front view of the projection system according to an exemplary embodiment; and

FIG. 3 is a view showing a correlation between a projection lens and a unit vector in a optical path that connects a second mirror and a third mirror.

### MODE FOR THE INVENTION

Hereinafter, an exemplary embodiment of the present invention will be described in detail with reference to the accompanying drawings.

However, the subject matters of the present invention are not limited to the following embodiments and those skilled in the art understanding the subject matters of the present invention can easily propose various embodiments included in the scope of the same subject matters by adding, changing, cancelling, etc, by components, which should be construed as being included in the subject matters of the present invention.

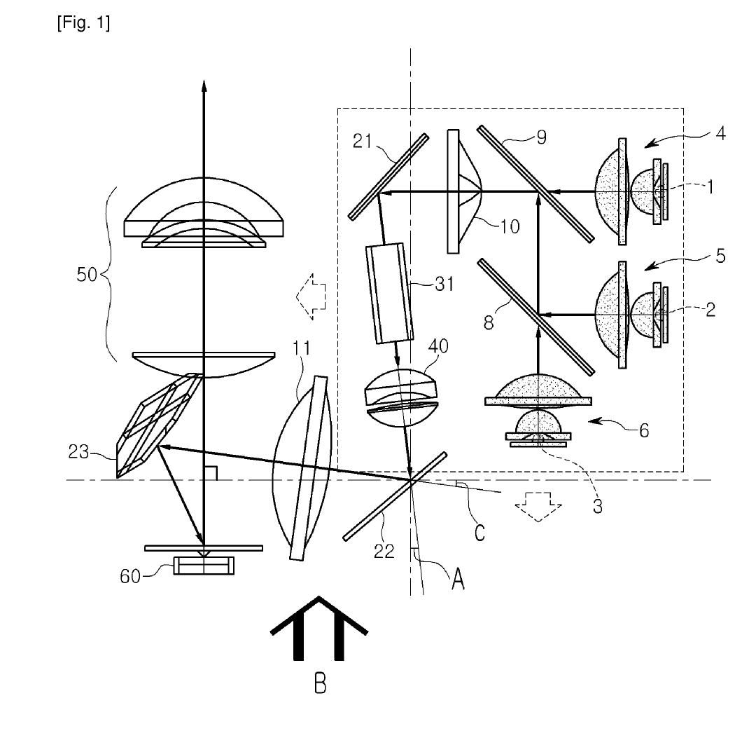

FIG. 1 is a structural view of a projection system according to an exemplary embodiment and shows a plan view.

Referring to FIG. 1, the projection system includes a first light-emitting device 1, a second light-emitting device 2, a third light-emitting device 3, collimators 4, 5, and 6 that focus light emitted from the light-emitting devices 1, 2, and 3, dichroic mirrors 8 and 9 that accurately synthesizes three colors of red, green, and blue, a first condensing lens 10 that focuses light, a first mirror 21 that reflects light, an integrator 31 that equally makes brightness of light into planar light within the overall region of an image, a relay lens 40, a second minor 22 that reflects light, a second condensing lens 11 that focuses light, a DMD 60, a third minor 23 that is interposed between the DMD 60 and the second condensing lens 11 and reflects the optical path to a side of the DMD 60, and a projection lens that projects light to a screen.

The DMD 60 is provided with a plurality of small-sized mirrors whose reflection angle is controlled and controls image signals according to whether reflection light faces the projection lens 50 or not on the base of the reflection angles of the small-sized mirrors. The DMD 60 is a known article and therefore, the detailed description thereof will not be repeated.

Each component of the projection system will be described in detail.

<Light-Emitting Devices 1, 2, and 3>

On/Off of the light-emitting devices should be controlled at very short instant. Preferably, as the light-emitting device, a light-emitting diode (LED) can be used. The first light-emitting device 1 is blue, the second light-emitting device 2 green, the third light-emitting device red. Each of these light-emitting devices light-emits colors corresponding to three colors of light. The light-emitting devices 1, 2, and 3 are temporally synchronized with the DMD 60 such that the light-emitting devices 1, 2, and 3 meeting the operation state of the current DMD 60 are sequentially turned-on/off at a time difference and three colors of red, green, and blue are time-serially projected on the screen. A user cannot discriminate the colors corresponding to the time-serially projected light and recognizes it as a single color.

<Collimators 4, 5, and 6>

The collimators 4, 5, and 6 are lenses that primarily focus light emitted from the light-emitting devices 1, 2, and 3. The collimator may be provided in plural number. Among others, the lenses, that are most adjacent to the light-emitting devices 1, 2, and 3, are provided in a form where one surface is convex and one surface is concave and is manufactured in a form where the light-emitting devices 1, 2, and 3 are inserted into a concaved one surface. By the above configuration, light emitted from the light-emitting devices 1, 2, and 3 is not leaked to the outside, such that light is effectively irradiated to the collimators and can be used as an effective light source of the projection system.

When the collimator a case of a collimator that is provided as a resin material so as to improve color purity of light emitted from each light-emitting device, dyes corresponding to colors themselves can provide colors to the collimator. When the collimator is provided as a resin material or glass, films corresponding to colors are coated on a surface of each of the surfaces of the corresponding collimators or paint is painted thereon. By this structure, the color purity of light emitted from the light-emitting device can be more improved.

<Dichroic Mirror>

The dichroic minors 8 and 9 are a minor that selectively transmits or reflects light and is set to be fitted to types of the light-emitting devices 1, 2, and 3. In detail, the first dichroic mirror 8 transmits red light emitted from the third light-emitting device 3 and reflects green light emitted from the second light-emitting device 2. The second dichroic mirror 9 transmits blue light emitted from the first light-emitting device 1 and reflects green light and red light emitted from the second and third light-emitting devices 2 and 3. Each light emitted from the plurality of light-emitting devices 1, 2, and 3 by the dichroic mirrors 8 and 9 can pass through the single optical path.

<Condensing Lenses 10 and 11>

The condensing lenses 10 and 11 serves as a convex lens that prevents a diffusion of light due to wave property of light.

<Mirrors 21, 22, and 23>

The minors 21, 22, and 23 are provided to reduce the volume of the projection system by integrating the structure of the projection system and distorts the optical path within the same volume. The arrangement state of the minors, which is one characteristic of the present invention, will be described in detail at a latter portion that describes the action of the embodiments.

<Integrator 31>

The integrator 31, which is provided to make light emitted from the light-emitting devices 1, 2, and 3 into a planar light, is to allow images projected on the screen to have the same brightness. The integrator 31 uses a fly eye lens or a light tunnel. In the present embodiment, the light tunnel is used. Further, as an optic axis of the integrator 31 moves to a light emitting side (herein, the movement direction of light is opposite to the movement direction of light), it becomes more distant from the optic axis of light passing through the projection lens 50 (hereinafter, sometimes referred to the optic axis of the projection lens). This contributes to achieving the small-sized projection system. The action thereof will be described later. Also, the integrator 31 can be manufactured by a light funnel where an area of a light incident side is larger than a light emitting side in order to increase the use efficiency of light.

<Relay Lens 40>

The relay lens 40, which focuses light emitted from the integrator 31, plays a role of preventing the diffuse of light emitted from the integrator 31 and re-focusing light. Two relay lenses 40 are used, such that the size of the projection system is more reduced.

<DMD 60>

The DMD has a structure where a plurality of small-sized mirrors capable of controlling a reflection angle are integrated, wherein the small-sized mirrors correspond to each pixel to determine whether images are focused or not according to whether the reflected light appropriately passes through the projection lens 50.

The projection system having the above-mentioned configuration will be described.

The light emitted from the light-emitting devices 1, 2, and 3 is focused by the collimators 4, 5, and 6. At this time, the collimators 4, 5, and 6 can improve the color purity of light emitted from each of the light-emitting devices 1, 2, and 3 by a method of coating/painting the surface of the collimator or a method of allowing the materials of the collimator itself to include dyes, and the like. This it to make natural light as maximally as possible by removing light having different wavelength bands in consideration of other light having wavelength bands different from the natural light according to the types of the semiconductor compounds of the LED, when the LED is as the light-emitting device.

Further, the light-emitting devices 1, 2, and 3 are light-emitted in a time-division scheme in the state where they are synchronized with the DMD 60 and the light-emitting devices 1, 2, and 3 corresponding to the current on/off state of the small-sized reflection minors formed on the DMD 60 are selectively light-emitted.

In the light passing through the collimators 4, 5, and 6, only the light synchronized with the current DMD 60 passes through the optical path during passing through the dichroic mirrors 8 and 9. If the light passes through the second dichroic minor 9, it passes through the first condensing lens 10 and is re-focused, which is in turn reflected by the first mirror 21.

The first mirror 21 sets the incidence angle and the reflection angle to be larger than 45°. Referring to FIG. 1, this is to deflect the light reflected from the first minor 21 to the right when the reflected light is downwardly. By the configuration, it is possible to satisfy a length of an optical path necessary for the projection system as well as reduce the physical size of the projection system. In detail, when the light emitted from the DMD 60 is based on the direction of light emitted through the projection lens 50, that is, the optic axis of the projection lens, the angle A formed by the light reflected from the first mirror 21 and the optic axis of the projection lens is set to be larger than 0. Preferably, the range of the angle A is 2 to 18° having a difference by 8° based on 10°. By this configuration, each component of a portion partitioned by a dotted line in FIG. 1 can be disposed to be more deflected to the left based on FIG. 1, such that the size of the left and right direction of the projection system can be reduced. In other words, referring to FIG. 1, a right end of the projection system can further move to the left. Herein, it is preferable to increase the size of the angle A. However, this causes the non-uniformity of brightness of light in left and right directions inside the complicated optical path or reduces the use efficiency of light. Even when the angle A increases, the minaturization is limited due to the interference between the projection lens and the space partitioned by the dotted line. Further, if the angle A is smaller than the proposed angle, the degree of miniaturization of the projection system becomes small such that it is not impossible to obtain the effect of miniaturization that is one of the objects of the present invention.

The light passing through the first mirror 21 is a planar light in the integrator 31 and is focused through the relay lens 40. Thereafter, it is reflected from the second mirror 22.

The light reflected from the second mirror 22 moves upwardly with reference to FIG. 1. In detail, in FIG. 1, an angle C formed by an orthogonal direction and the light reflected from the second mirror 22 with respect to the optic axis of the projection lens is not parallel. As such, when the light reflected from the second minor 22 moves upwardly, the components of the projection system can move up to the lowest end of the projection system with reference to FIG. 1. In other words, each of the components of a portion partitioned by a dotted line in FIG. 1 further moves downwardly and is then disposed, such that the size in the up and down directions of the projection system can be reduced. However, in this case, the distance between the DMD 60 and the projection lens 50 may serve as a limit value, but a barrel length of the projection lens 50 can be actually reduced according to the design of the lens. As a result, the distance does not matter.

The light reflected from the second mirror 22 is focused through the condensing lens 11, reflected from the third mirror 23, and then incident into the DMD 60.

Herein, the third minor 23 and the condensing lens 11 are disposed at the left and right based on the optic axis of the projection lens 50. The optical path length along which light passes through the optical path of the projection lens 50 at least once can be assured, such that it can handle the projection system, which is a relative long focal point. By this configuration an optical path having a proper optical path length required for the projection system can be secured, the focusing of light can be achieved, the prism used for the surface of the DMD in the related art. Thereby, the loss of light and the high cost, which are caused by the prism, can be solved. Further, the inconvenience of manufacturing, which should precisely aligns the prism or the field lens to the optic axis, etc., can be solved.

In the DMD 60, by the operation of the small-sized reflection mirror, which is turned-on/off per the pixel, the light reflected by the small-sized reflection mirror in the state of the turn-on state is incident to the screen through the projection lens 50 to form images and the light reflected by the small-sized reflection mirror in the state of the turn-off state is lost without forming pixels on the screen. The images are formed on the screen by the collection of the reflection light by each of the small-sized reflection minor.

According to the above description, the cost save can be achieved due to the removal of the prism used for the reflection surface of the DMD 60 and the problem of the loss of light caused by the prism can be solved. The components partitioned by a dotted line in FIG. 1 by controlling the reflection angle of the first minor 21 and the second minor 22 moves to the left and lower side based on FIG. 1 (see an arrow), such that the size of the projection size can be miniaturized. The loss of light of the light-emitting device can be reduced and the use efficiency of light can be improved, by providing the convex lens near the light emitting sides of the light-emitting devices 1, 2, and 3 among the lenses of the collimator, wherein one side of the convex lens is concave and the other thereof is convex. The collimator itself is provided with a function of improving the color purity, making it possible to further improve the image quality. Further, comparing with the case of using the prism or the field lens, the fine control of the optic axis is not needed, such that the difficulty in an assembling site can be reduced.

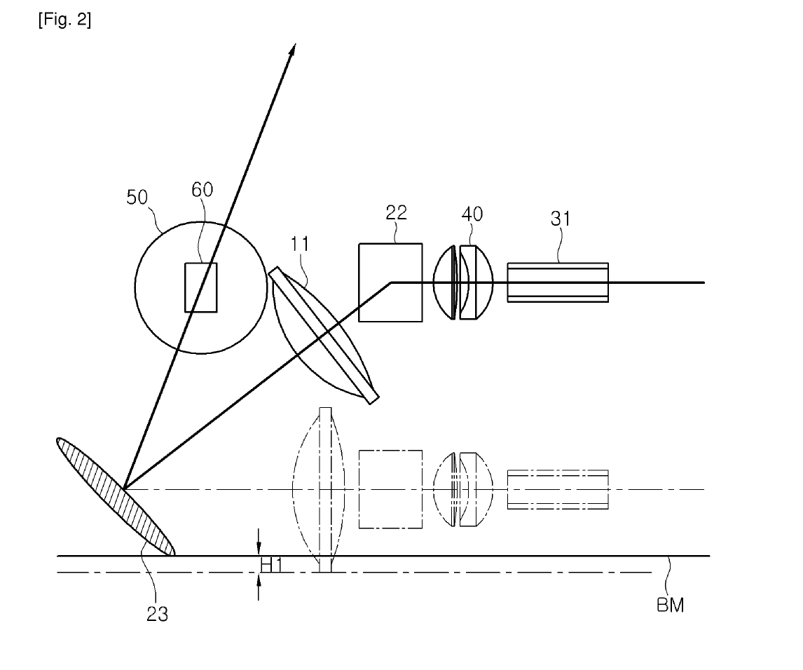

FIG. 2, which is a view showing the projection system viewed in an arrow “B” direction, is a front view of a configuration adjacent to a center of the projection lens.

Referring to FIG. 2, the integrator 31, the second minor 22, the third mirror 23, the DMD 60, and the projection lens 50 are shown. Herein, the integrator 31 is disposed on the upper side of the third mirror 23, such that the second mirror 22 moves the light passing through the integrator 31 downwardly.

According to the above configuration, the second condensing lens 11 can be inclinedly disposed (in the state where it moves upwardly the lower surface based on the bottom surface of the projection system) along the optical path. According to the above configuration, the height of the bottom surface of the projection system constrained by the second condensing lens having a relatively large size can be increased.

In detail, the second mirror 22 represented by a virtual line is compared with a structure that is disposed to be parallel with the bottom surface (BM) of the projection system so as to reflect light, the second condensing lens 11 moves upwardly. In this case, the bottom surface of the projection system constrained by the second condensing lens 11 can move to the higher position. Thereby, the up and down height of the projection system can be reduced by H₁. Further, the lowest height of the projection system is constrained by the third mirror 23 and the lowest height of the projection system is defined by the low end of the third minor 23. The second condensing lens 11 is largely provided to increase the focusing efficiency of light and the mounting position of the second condensing lens 11 can move upwardly from the bottom surface of the projection system, such that the size of the projection system is small.

When observing the optical path as described above, if the optic axis of the projection lens is referred to as the XYZ spatial coordinate system, the optic axis of light moving from the second minor 22 to the third minor 23 does not have the orthogonal or parallel relationship to any axis of XYZ-axes. Thereby, the miniaturization of the projection system can be achieved as described above. Of course, it can be easily appreciated that the reduction of the size of the projection system in an XY direction on the XYZ coordinate system can be achieved by distorting the angle A formed by the light reflected from the first minor 21 and the optic axis of the projection lens within the range of 2 to 18° having a difference by 8° based on 10°.

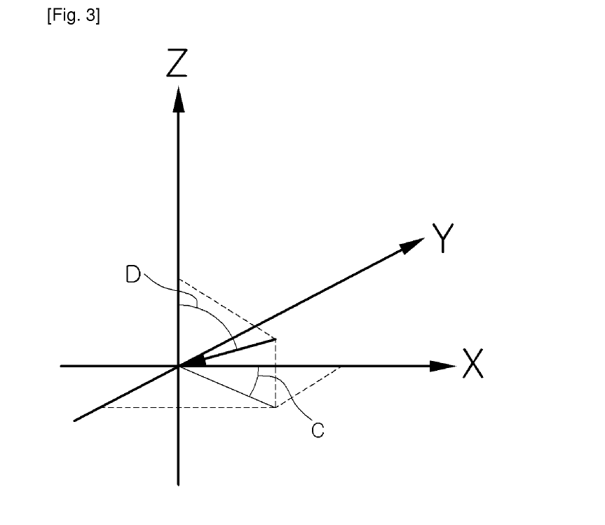

FIG. 3 is a view showing a correlation between the optic axis of the projection lens and a unit vector in a optical path that connects the second mirror and the third minor.

Referring to FIG. 3, in the XYZ three-dimensional coordinate system, the Z-axis means an up and down height of the projection system and an XY plane means the plane of the projection system in all directions. On the XYZ coordinates, if the Y-axis is referred to as an optic axis of the projection lens 50, the unit vector of the optical path, which connects the second minor and the third mirror, may be the same as one represented by a solid line of FIG. 3.

The unit vector is a negative vector moving toward a negative direction to the Z-axis and means one that moves downwardly by an angle “D” and means a vector that moves to the right upward on the plane. In other words, it is a vector that moves to the negative direction with respect to the X-axis and is a vector that moves to the positive direction with respect to the Y-axis. Since the angle of the unit vector does not form the parallel relationship to all the three directions, which are XYZ directions, in particular, the orthogonal or parallel relationship to the Z-axis, the unit vector does not have the parallel state with respect to the bottom surface (BM) of the projection system of the integrator 31, but is rotated by a predetermined angle.

Based on the plan view of the projection system shown in FIG. 1, the above-mentioned projection system can secure the optical path having the predetermined length since the unit vector moves to the right upward and the plane size of the projection system can be miniaturized. Based on the front view of the projection system shown in FIG. 2, the above-mentioned projection system can secure the optical path having the predetermined length and the size in the up and down directions of the projection system can be miniaturized, since the unit vector moves downwardly.

The ideas of the present invention can further include the following embodiments in addition to the above-mentioned embodiments. First, the light-emitting devices 1, 2, and 3 and the dichroic minors are a time division supplying device that time-divides light and supplies it. Herein, it can be understood that the time division supplying device of light includes a controlling device that time-divides the light emitted from the light-emitting devices 1, 2, and 3 and controls the on/off thereof. Herein, the time-division supplying device of light may be provided in a structure that time-divides light by passing through a white light-emitting device and a color filter rotating the light emitted from the white light-emitting device at a high speed and supplies it. Further, even when the dichroic mirror is used, the light-emitting device can be used by controlling the light-emitting time in the state where two or more light-emitting devices are mounted on a single mount structure.

Further, the projection system according to the embodiment makes the light from the light-emitting device into the planar light through the integrator 31 and focuses the images by the predetermined projection structure. However, the present invention is not limited to the above-mentioned structure and can use all the structures that makes light into the planar light before the light is incident to the second minor 22. For example, it may be permitted to make light into the planar light using the fly eye lens as well as to use a lamp as the light-emitting device. However, according to the ideas of the present invention to achieve the miniaturization, it is more preferable to use the structures shown in the above-mentioned embodiments.

### INDUSTRIAL APPLICABILITY

With the present invention, when the projection system is used as a projector, it can be conveniently carried. For example, a user can carry the projector in the state where the projector is put in the bag as one article, which can change the market of the projector as a new industry.

1. A projection system comprising:
at least one light-emitting device;
a time division supplying device of light that time-divides light emitted from the at least one light-emitting device and supplies it;
a first condensing lens that focuses light passing through the time division supplying device of light;
a first minor that reflects light passing through the first condensing lens;
an integrator that makes light reflected from the first minor into a planar light;
a second mirror that reflects light passing through the integrator;
a third minor that reflects light reflected from the second minor to a DMD side; and
a projection lens that projects light reflected from the second minor onto a screen and has an optic axis, at both sides of which the second minor and the third mirror are disposed respectively.

2. The projection system according to claim 1, wherein the front of the light-emitting device is provided with a collimator that uses at least a convex lens whose one surface is concave and the other is convex and the inside of the concave portion of the convex lens is provided with at least a portion of the light-emitting device.

3. The projection system according to claim 2, wherein the collimator is made of a resin material in which dyes are mixed or the surface of the collimator is coated by colors, in order to improve the color purity.

4. The projection system according to claim 1, wherein the third mirror defines a position of the lowest side of the projection system.

5. The projection system according to claim 1, wherein the light emitted from the integrator is distant from an optic axis of the projection lens as it is distant from the integrator.

6. The projection system according to claim 1, wherein the optic axis of the optical path, which connects the second minor and the third minor, is not orthogonal or parallel in all the XYZ directions based on the optic axis of the projection lens.

7. The projection system according to claim 6, wherein the integrator is rotated by a predetermined angle with respect to a bottom surface of the projection system.

8. The projection system according to claim 1, wherein the optic axis of the optical path, which connects the first mirror and the third mirror, is distorted within 2 to 18° with respect to the optic axis of the projection lens.

9. The projection system according to claim 1, wherein the at least one light-emitting device is a light-emitting diode of red, green, and blue, and the time division supplying device of light is provided with a dichroic lens that integrates each of the optical paths of light emitted from the light-emitting diode of red, green, and blue.

10. The projection system according to claim 1, wherein two relay lenses are provided between the integrator and the second minor.

11. A projection system that forms images on the screen in a time division scheme, wherein an optic axis of an optical path passing through a projection lens and an optic axis of an optical path passing through an integrator that makes light into a planar light corresponding to the images are distorted in the range of 2 to 18°.

12. The projection system according to claim 11, wherein light emitted from the integrator is distant from an optic axis of the projection lens as it is distant from the integrator.

13. A projection system comprising:
at least one light-emitting device;
a time division supplying device of light that time-divides light emitted from the at least one light-emitting device and supplies it;
an integrator that makes light time-divided and supplied from the first minor into a planar light;
at least one condensing lens that focuses light;
at least three reflection minors;
a DMD that receives light reflected from the at least three minors; and
a projection lens that projects light emitted from the DMD onto a screen, wherein an optic axis that connects a second minor disposed at an emitting side of the integrator and a third mirror disposed at an incident side of the DMD is not orthogonal or parallel to any of XYZ-axes on a virtual XYZ coordinate system using the optic axis of the projection lens as a Y-axis.

14. The projection system according to claim 13, wherein the lowest height of the projection system is limited by the third minor.

15. The projection system according to claim 13, wherein among the at least one condensing lenses, the condensing lens, which is interposed between the second mirror and the third mirror, is inclinedly disposed to a bottom surface of the projection system.

16. The projection system according to claim 13, wherein an optic axis of the optical path passing through the projection lens and an optic axis of the optical path passing through the integrator are distorted in the range of 2 to 18°.

17. The projection system according to claim 13, further comprising a first mirror that reflects the time-divided light by passing through the time division supplying device to the integrator.

18. The projection system according to claim 13, wherein the optical path, which connects the second mirror and the third mirror, moves upwardly when being viewed from a horizontal plane.

19. The projection system according to claim 13, wherein the optical path of the second mirror and the third mirror is provided with the condensing lens.

20. The projection system according to claim 19, wherein the condensing lens and the third minor are each disposed at different side from each other by the optic axis of the projection lens.
